(19) United States
(12) Patent Application Publication
(10) Pub. No.: US 2018/0075297 A1
(43) Pub. Date: Mar. 15, 2018

(54) SYSTEM FOR HANDLING LUGGAGE AND METHOD THEREOF

(71) Applicant: Hanseo University Academic Cooperation Foundation, Seosan-si (KR)

(72) Inventors: Kang Seock LEE, Chungcheongnam-do (KR); Won Hyuck CHOI, Chungcheongnam-do (KR)

(73) Assignee: Hanseo University Academic Cooperation Foundation, Seosan-si (KR)

(21) Appl. No.: 15/674,868

(22) Filed: Aug. 11, 2017

(30) Foreign Application Priority Data
Sep. 9, 2016 (KR) 10-2016-0116122
Sep. 9, 2016 (KR) 10-2016-0116463

(51) Int. Cl. G06K 9/00; G01G 19/414; G06K 19/02; B64F 1/36

(52) U.S. Cl. CPC G06K 9/00442; G06K 9/00087; G06K 9/00288; G07B 15/00; G06K 19/025; B64F 1/366; G01G 19/414

(57) ABSTRACT

Disclosed is a system for handling luggage and method thereof, the system including: a passport reader reading information on a passport and determining whether the passport is normal; a fingerprint reader reading a fingerprint and determining whether the fingerprint corresponds to the information; a face reader reading a face and determining whether the face corresponds to the information; a boarding pass reader reading a boarding pass and verifying a destination; a luggage measurement unit measuring weight of check-in luggage and determining whether the weight exceeds a permissible criterion; a payment processor processing payment when the weight exceeds the criterion; a luggage tag issuing unit issuing a tag for the luggage after the payment and attaching the tag to the luggage; a luggage tag reader reading the tag and verifying the destination; and a central controller controlling the above-described readers, the above-described units, and the payment processor.

### CROSS REFERENCE TO RELATED APPLICATION

The present application claims priority to Korean Patent Application No. 10-2016-0116122 filed filed Sep. 09, 2016, and No. 10-2016-0116463 filed Sep. 09, 2016, the entire contents of which is incorporated herein for all purposes by this reference.

### BACKGROUND OF THE INVENTION

### Field of the Invention

The present invention relates generally to a system for handling luggage and method thereof. More particularly, the present invention relates to a system for handling check-in luggage and method thereof to reduce check-in time.

### Description of the Related Art

Currently, numerous airports in the world utilize unstaffed kiosks, etc. for unstaffed check-in services to solve the problem that airport check-in times are substantially long.

However, most passengers carry luggage to be checked. Thus, even though the passengers check in by using the unstaffed kiosk, the passengers must ultimately use a staffed counter to check in luggage.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a system for handling check-in luggage and method thereof in the manner of unstaffed counter, whereby check-in time of passengers using an airport can be reduced and airport service can be enhanced.

In order to achieve the above object, according to one aspect of the present invention, there is provided a system for handling check-in luggage, the system including: a passport reader reading information on a passport of a passenger and determining whether or not the passport is normal; a fingerprint reader reading a fingerprint of the passenger and determining whether or not the fingerprint corresponds to the information on the passport; a face reader reading a face of the passenger and determining whether or not the face corresponds to the information on the passport; a boarding pass reader reading a boarding pass of the passenger and verifying information on a destination for the passenger; a luggage measurement unit measuring weight of check-in luggage and determining whether or not the weight exceeds a permissible criterion; a payment processor processing payment when the weight exceeds the permissible criterion; a luggage tag issuing unit issuing a tag for the check-in luggage when the payment for the check-in luggage has been processed and attaching the tag to the check-in luggage; a luggage tag reader reading the tag of the check-in luggage and verifying the destination for the check-in luggage; and a central controller controlling the passport reader, the fingerprint reader, the face reader, the boarding pass reader, the luggage measurement unit, the payment processor, the luggage tag issuing unit, and the luggage tag reader.

The payment processor may charge for an excess weight when the weight of the check-in luggage exceeds the permissible criterion.

Also, according to another aspect of the present invention, there is provided a method of handling check-in luggage, the method including: reading information on a passport of a passenger and determining whether or not the passport is normal; reading a fingerprint of the passenger and determining whether or not the fingerprint corresponds to the information on the passport; reading a face of the passenger and determining whether or not the face corresponds to the information on the passport; reading a boarding pass of the passenger and verifying information on a destination for the passenger; measuring weight of check-in luggage and determining whether or not the weight exceeds a permissible criterion; issuing a tag for the check-in luggage when payment for the check-in luggage has been processed and attaching the tag to the check-in luggage; and reading the tag of the check-in luggage, verifying the destination for the check-in luggage, and transferring the check-in luggage.

The method may further include processing the payment when the weight exceeds the permissible criterion after the measuring of the weight of the check-in luggage and the determining of whether or not the weight exceeds the permissible criterion.

According to the present invention as described above, the system for handling check-in luggage and method thereof can reduce waiting time and check-in time of passengers using an airport, thereby enhancing airport service.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram illustrating a system for handling check-in luggage according to an embodiment of the present invention; and

FIG. 2 is a flowchart illustrating a method of handling check-in luggage according to an embodiment of the present invention.

### DETAILED DESCRIPTION OF THE INVENTION

Hereinbelow, an exemplary embodiment of the present invention will be described in detail with reference to the accompanying drawings such that the present invention can be easily embodied by one of ordinary skill in the art to which this invention belongs. However, it will be understood that the present invention may be realized in various forms and are not limited to the embodiments described herein.

A system for handling check-in luggage and method thereof according to an embodiment of the present invention will be described with reference to the accompanying drawings.

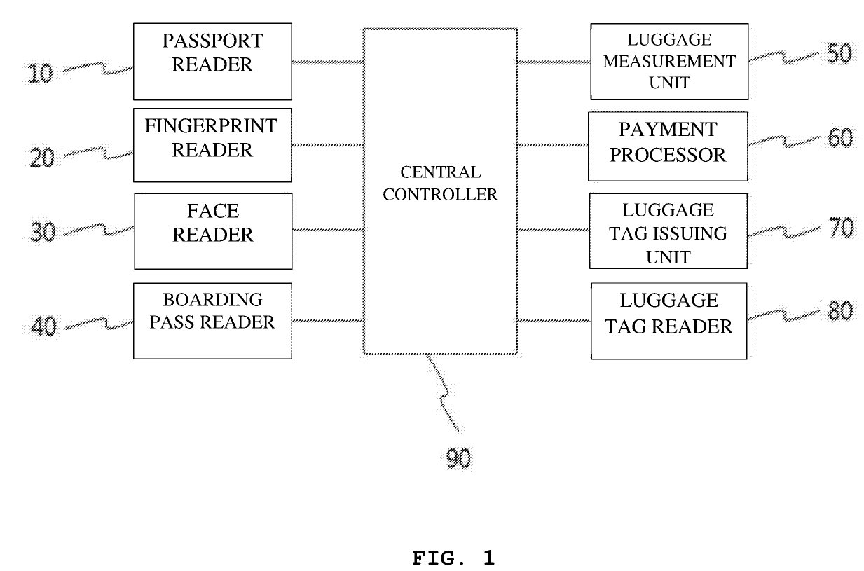

FIG. 1 is a block diagram illustrating a system for handling check-in luggage according to an embodiment of the present invention.

Referring to FIG. 1, the system for handling check-in luggage of the present invention may include a passport reader 10, a fingerprint reader 20, a face reader 30, a boarding pass reader 40, a luggage measurement unit 50, a payment processor 60, a luggage tag issuing unit 70, a luggage tag reader 80, and a central controller 90.

The passport reader 10 may read information on a passport of a passenger, and may verify the identity of the passenger.

The fingerprint reader 20 may read a fingerprint of the passenger, and may determine whether or not the fingerprint corresponds to the information on the passport.

The face reader 30 may photograph the face of the passenger, and may determine whether or not the face of the passenger corresponds to the photograph of the passport.

The boarding pass reader 40 may verify a boarding pass of the passenger, and may determine whether or not the boarding pass corresponds to the information on the passport.

The luggage measurement unit 50 may measure the quantity of and the weight of the check-in luggage, and may determine whether or not the quantity and the weight exceed permissible criteria.

The payment processor 60 may receive information from the luggage measurement unit 50, and may process payment for the excess quantity or weight.

The luggage tag issuing unit 70 may issue a tag for the luggage when the payment for the luggage has been processed, and may attach the tag to the luggage.

The luggage tag reader 80 may read the attached luggage tag so as to transfer the luggage.

When a passenger checks in the luggage, first, a passenger picks up an airline ticket at the check-in counter.

Next, the passenger moves to an automatic luggage handling place where several automatic luggage handling devices are provided. The passenger enters the automatic luggage handling place by having the airline ticket verified at the entrance, and moves to an unoccupied automatic luggage handling device to check in the luggage.

First, the passport is read by the passport reader 10, and then the fingerprint is read by the fingerprint reader 20, and the face is read by the face reader 30, whereby the identity of the passenger is verified.

Next, flight information is input by reading the airline ticket, and the passenger inputs the quantity of the check-in luggage. Next, when the passenger puts the check-in luggage on the luggage measurement unit 40, the weight of the check-in luggage is automatically measured, and whether or not the weight exceeds the permissible criterion is determined.

When the weight of the check-in luggage exceeds the permissible criterion, the payment processor 60 processes the payment so as to charge for the excess weight.

After processing the payment by the payment processor 60, the luggage tag issuing unit 70 issues a tag and attaches the tag to the luggage. Next, the luggage is moved to the luggage tag reader 80 via the conveyer belt (not shown).

The luggage tag reader 80 reads the tag attached to the luggage, and provides information to the central controller 90 so as to transfer the luggage into the corresponding flight.

The central controller 90 controls the system for handling the check-in luggage of the present invention so as to transfer the luggage into the corresponding flight without mistake.

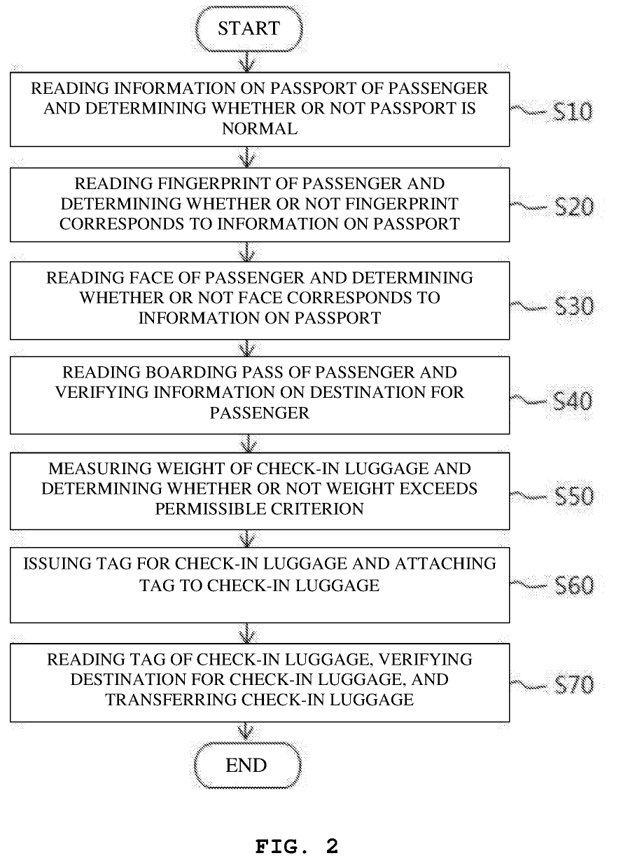

FIG. 2 is a flowchart illustrating a method of handling check-in luggage according to an embodiment of the present invention.

Referring to FIG. 2, in the method of handling luggage according to an embodiment of the present invention, first, the information on the passport of a passenger is input, and the identity of the passenger is verified by the passport reader 10 at step S10.

Next, the fingerprint of the passenger is input, and whether or not the fingerprint corresponds to the information on the passport is determined by the fingerprint reader 20 at step S20.

Next, the face of the passenger is photographed, and whether or not the face corresponds to the photograph of the passport is determined by the face reader 30 at step S30.

Next, the boarding pass of the passenger is read, and whether or not the boarding pass corresponds to the information on the passport is determined by the boarding pass reader 40 at step S40.

Next, the quantity of and the weight of the check-in luggage are measured, and whether or not the quantity and the weight exceed the permissible criteria is determined by the luggage measurement unit 50 at step S50. Here, information from the luggage measurement unit 50 is received, and the payment for the excess quantity or weight is processed by the payment processor 60.

Next, a tag for the luggage is issued by the luggage tag issuing unit 70 when payment for the luggage has been processed, and the tag is attached to the luggage at step S60.

Next, the attached luggage tag is read by the luggage tag reader 80, and then the luggage is transferred at step S70.

According to the present invention, waiting time and check-in time for check-in luggage of the passenger can be reduced. Also, the present invention can prevent luggage from being incorrectly transferred and from being transported to a wrong airport by being controlled by a computer (not shown).

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A system for handling check-in luggage, the system comprising:
a passport reader reading information on a passport of a passenger and determining whether or not the passport is normal;
a fingerprint reader reading a fingerprint of the passenger and determining whether or not the fingerprint corresponds to the information on the passport;
a face reader reading a face of the passenger and determining whether or not the face corresponds to the information on the passport;
a boarding pass reader reading a boarding pass of the passenger and verifying information on a destination for the passenger;
a luggage measurement unit measuring weight of check-in luggage and determining whether or not the weight exceeds a permissible criterion;
a payment processor processing payment when the weight exceeds the permissible criterion;
a luggage tag issuing unit issuing a tag for the check-in luggage when the payment for the check-in luggage has been processed and attaching the tag to the check-in luggage;
a luggage tag reader reading the tag of the check-in luggage and verifying the destination for the check-in luggage; and
a central controller controlling the passport reader, the fingerprint reader, the face reader, the boarding pass reader, the luggage measurement unit, the payment processor, the luggage tag issuing unit, and the luggage tag reader.

2. The system of claim 1, wherein the payment processor charges for an excess weight when the weight of the check-in luggage exceeds the permissible criterion.

3. A method of handling check-in luggage, the method comprising:
reading information on a passport of a passenger and determining whether or not the passport is normal;
reading a fingerprint of the passenger and determining whether or not the fingerprint corresponds to the information on the passport;
reading a face of the passenger and determining whether or not the face corresponds to the information on the passport;
reading a boarding pass of the passenger and verifying information on a destination for the passenger;
measuring weight of check-in luggage and determining whether or not the weight exceeds a permissible criterion;
issuing a tag for the check-in luggage when payment for the check-in luggage has been processed and attaching the tag to the check-in luggage; and
reading the tag of the check-in luggage, verifying the destination for the check-in luggage, and transferring the check-in luggage.

4. The method of claim 1, further comprising:
processing the payment when the weight exceeds the permissible criterion after the measuring of the weight of the check-in luggage and the determining of whether or not the weight exceeds the permissible criterion.
